(19) United States
(12) Patent Application Publication
(10) Pub. No.: US 2008/0071846 A1
(43) Pub. Date: Mar. 20, 2008

(54) Processor Architecture for Programmable Digital Filters in a Multi-Standard Integrated Circuit

(75) Inventors: Mangesh Devidas Sadafale, Maharashtra (IN); Himamshu Gopalakrishna Khasnis, Bangalore (IN); Konrad Kratochwil, Sunnyvale, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/854,166

(22) Filed: Sep. 12, 2007

Related U.S. Application Data
(60) Provisional application No. 60/825,661, filed on Sep. 14, 2006.

(51) Int. Cl. G06F 17/17

(52) U.S. Cl. 708/313

(57) ABSTRACT

An architecture for a cascaded digital filters comprises independently programmable controlling registers and independent interpolating factors; a digital to analog converter for converting the digital signals into analog signals with a constant sampling rate which matches with the interpolating factors of the cascaded digital filters. Each filter property (filters order, coefficient symmetry, half-band, and poly-phase) can be programmed independently to support different system requirements and extract maximum throuput from a given hardware. The method of filtering digital signals comprises the steps of determining an interpolation factor of the cascaded digital filters with the lowest number of computations so as to match with the single sampling rate of the digital to analog converter, determining active filters and an interpolation factor of each digital filter in the cascaded digital filters, and determining a mode of operation of the cascaded digital filters.

### CROSS-REFERENCE TO RELATED APPLICATION

This application claims the benefit of U.S. provisional applications 60/825,661 filed on Sep. 14, 2006, which is herein incorporated by reference.

### FIELD

Embodiments of the invention relates to high speed digital communication systems and more specifically to a processor architecture for programmable digital filters in a multi-standard integrated circuit.

### BACKGROUND

A model of communication system is usually formed by a source which is a Digital Signal Processor (DSP) followed by a transmitter that comprises a digital filter, a DAC converter and an analog filter. After modulation using IFFT (Inverse fast Fourier Transform) or cyclic prefix addition, the transmitter performs several states of digital filtering followed by a digital to analog conversion (DAC) in order to match the DAC sampling rate. The outputs of the DAC are then transmitted to a receiver through a channel. On the other side of the channel, a receiver which consists of an Analog to Digital Converter (ADC) and a digital filter followed by a sink which is also a DSP, converts the analog signals into digital signals before transmitting them to the sink.

In typical communications and signal processing systems, standards have evolved in order to meet and to comply with the different market requirements or standards. In a Digital Subscriber Line (DSL) communication, the communication devices are devised to achieve high data rates transmission through the use of multi-carrier modulation (MCM) technique which is also referred to as discrete multi-tone modulation (DMT). For a DSL chip where a single system is provided, in order to support the different standards, the DSL chip has to implement different hardware along with the different configurations. The traditional digital filter implementation does not enable to program the parameters of each digital filter in order to change its properties, such as the filter order, the coefficients, the interpolation factors of the transmitter, the decimation factors for the receiver, etc.

Therefore, because of the lack of programmability and because of the needs for the transfer functions and the input/output data rates to be adapted to the standards of the different standards, a large number of low area filters have to be implemented. And in the case of a chain of several digital filters, the total area of all the digital filters can very large.

Another option is to implement a digital filter using a programmable DSP such as a C62x. The programmable DSP does provide software flexibility when used in connection with a desired digital filter for a given standard. However, this option is not optimal for two reasons: first because of the large size of the hardware of the programmable DSP, and second because of the absence of any control on quantization noise. There is no control on quantization noise since the filter data-width is limited by the size of the available multipliers in the programmable DSP. Should the digital filter requires more data-width for better quantization noise, the programmable DSP would have to use expensive double precision formats.

For instance, the double precision formats are required in the case of a C62x DSP running at 360 MHz and implementing a 71 order non-symmetric FIR filter. In such implementation, in order to process one output sample, this digital filter needs 72 multiplications and 73 additions. With two 16-bit multipliers and three 32-bit adders in the C62x, 36-clocks are required. Accordingly, 20% of the programmable DSP MIPS is consumed by the digital filter to process data at 2 MHz data-rate.

And in case a chain of digital filters is implemented combined with a higher data-rate, the use of the programmable DSP MIPS requirement is even higher. Thus, almost all the available MIPS is consumed by the chain of digital filters. Not to mention that additional program memory is needed to store the digital filter program. Therefore, the use of a programmable DSP for a digital filter implementation is not a desired option.

In order to avoid the maximum operating frequency limitation and higher area of the programmable DSP, an ASIC implementation may be a solution. Although the traditional low-area of ASIC implementation provides area benefit, it does not provide the flexibility to change the digital filter configuration. Conversely, the DSP provides the configuration flexibility but at the cost of a huge area requirement. Therefore, there is a need for a programmable digital filter which does not use a large area of the hardware resource of an integrated circuit.

### SUMMARY

These and other problems are generally solved or circumvented, and technical advantages are generally achieved, by preferred embodiments of the present invention which provides a method and an processor architecture of a chain of cascaded digital filters designed to support multiple standards in an integrated circuit on the transmitter side as well as on the receiver side.

In light of the foregoing background, embodiments of the invention provide a novel processor architecture wherein each digital filter property such as filters order, coefficient symmetry, half-band, and poly-phase can be programmed independently in order to support the different standard requirements such as a multiple DSL applications and to extract the maximum throuput from a given hardware.

In accordance with an embodiment of the invention, in a programmable digital filtering device composed of a cascaded digital filters, wherein the digital signals are transmitted from a source with multiple sampling rates to a digital to analog converter with a single sampling rate, a method of filtering digital signals comprises the steps of:
determining an interpolation factor of the cascaded digital filters with the lowest number of computations so as to match with the single sampling rate of the digital to analog converter;
determining active filters and an interpolation factor of each digital filter in the cascaded digital filters; and
determining a mode of operation of the cascaded digital filters.

In accordance with another embodiment of the invention, a processor architecture for transmitting digital signals comprises a programmable digital filtering device coupled to a source for filtering digital signals generated by the source at multiple sampling rates. The programmable digital filtering device includes:
a cascaded digital filters with independently programmable controlling registers and independent interpolating factors; and
a digital to analog converter for converting the digital signals into analog signals with a constant sampling rate which matches with the interpolating factors of the cascaded digital filters.

In accordance with yet another embodiment of the invention, a processor architecture for receiving digital signals comprises a programmable digital filtering device coupled to a Sinc at multiple sampling rates for filtering the digital signals received at a constant sampling rate. The programmable digital filtering device includes:
a cascaded digital filters with independently programmable controlling registers and independent decimating factors; and
an analog to digital converter for converting the analog signals into digital signals with a multiple sampling rate which matches with the decimating factors of the cascaded digital filters.

In accordance with an embodiment, the programmable controlling registers comprise DFx_order registers which determine an order of each of the cascaded digital filters, DFx_symmetric registers which determine coefficients symmetric property of each of the cascaded digital filters and/or DFx_hb registers which determine half-band property of each of the cascaded digital filters.

In accordance with another embodiment, the processor architecture comprises a single-port DATA RAM with two instances DATA1 RAM and DATA2 RAM to support the symmetric coefficient property and a single-port Coefficient RAM which is programmed with the coefficients of active digital filters of the cascaded digital filters.

These and other features and aspects of the invention will be apparent to those skilled in the art from the following detailed description of the invention, taken together with the accompanying drawings.

### BRIEF DESCRIPTION OF THE DRAWINGS

Having thus described the invention in general terms, reference will now be made to the accompanying drawings, which are not necessarily drawn to scale, and wherein:

FIG. 1A shows an implementation of a poly-phase interpolating digital filter.

FIG. 1B shows an implementation of a symmetric coefficient digital filter.

FIG. 2 shows a chain of cascaded interpolating digital filters on the transmitter side of a channel according to the present invention.

FIG. 3 shows a particular implementation of an infinite impulse response (IIR) digital filter DF1 according to the present invention.

FIG. 4 shows an illustrative implementation block diagram of the hardware (ALU) according to the present invention.

FIG. 5 shows a particular segmentation of a DATA RAM of a digital filter according to the present invention.

FIG. 6 shows a particular segmentation of a Coefficient RAM of a digital filter according to the present invention.

FIG. 7 shows the compute unit of the Arithmetic Logic Unit (ALU).

FIG. 8 shows a state diagram illustrative of the states for a particular mode (MODE#4).

FIG. 9 shows a chain of cascaded decimating digital filters on the receiver side of the channel according to the present invention.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

An interpolation operation enables to increase the sampling rate by filling in in-between samples of x(n), by zeros for instance. An interpolation factor L means that “L” zeros are inserted between every alternate sample x(n) so to obtain a signal with a scaled frequency response that is replicated L times over a 2π interval. x(n) is a sequence of discrete input values which are processed by a digital filter or a chain of digital filters to produce a sequence of discrete values y(n).

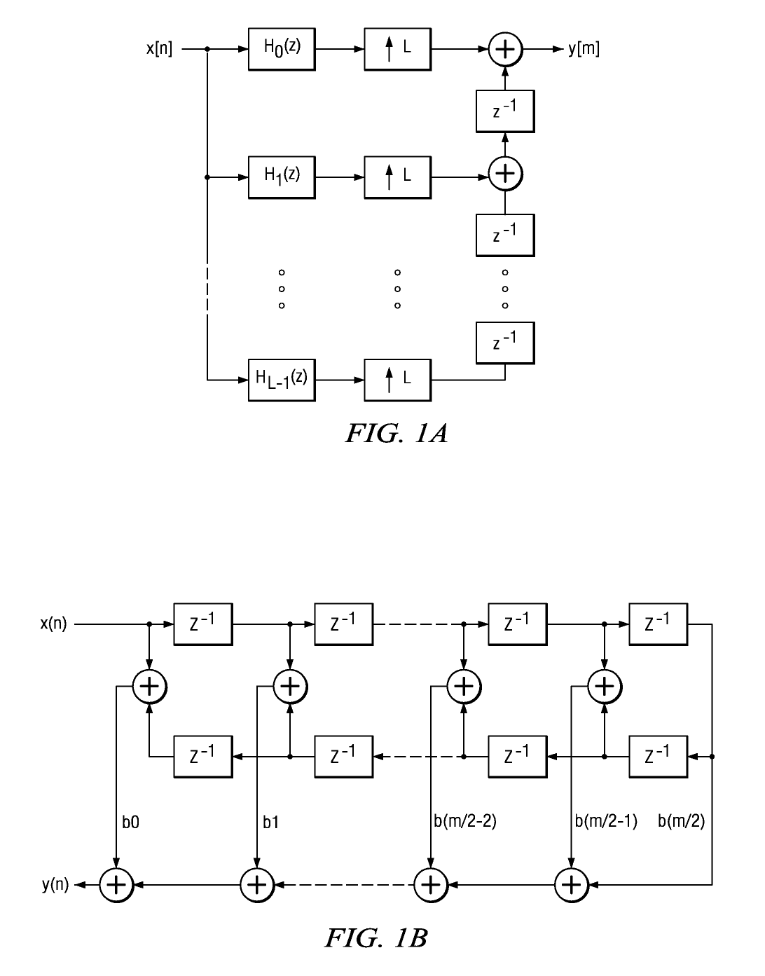

In order to reduce further the computation requirement, a poly-phase structure in combination with an interpolation factor L can be implemented. FIG. 1A shows an implementation of a plurality of poly-phase interpolating digital filters characterized by transfer functions Hᵢ(z) to which a plurality of zero insertion blocks are cascaded with a plurality of Low-Pass Filtering (LPF) interpolators having an interpolator factor L.

For a Finite Impulse Response (FIR) digital filter of “m” order, the poly-phase structure, as shown in FIG. 1A, will reduce the multiplication to “(m+1)/L” as compare to “(m+1)” in normal implementation.

When the FIR filter is in linear phase, its coefficients are symmetric such that coefficients b₍ᵢ₎=b₍ₘ₋ᵢ₎ in an implementation as show in FIG. 1B where the total multiplication required is “fix(m/2)+1”. Therefore, with the use of the symmetric property, it is possible to reduce the required number of multiplication to almost half, and accordingly, the hardware required to store the coefficients is also reduced by half.

Furthermore, by using the half band property of the interpolating filter coefficients, the computational requirement can be further reduced.

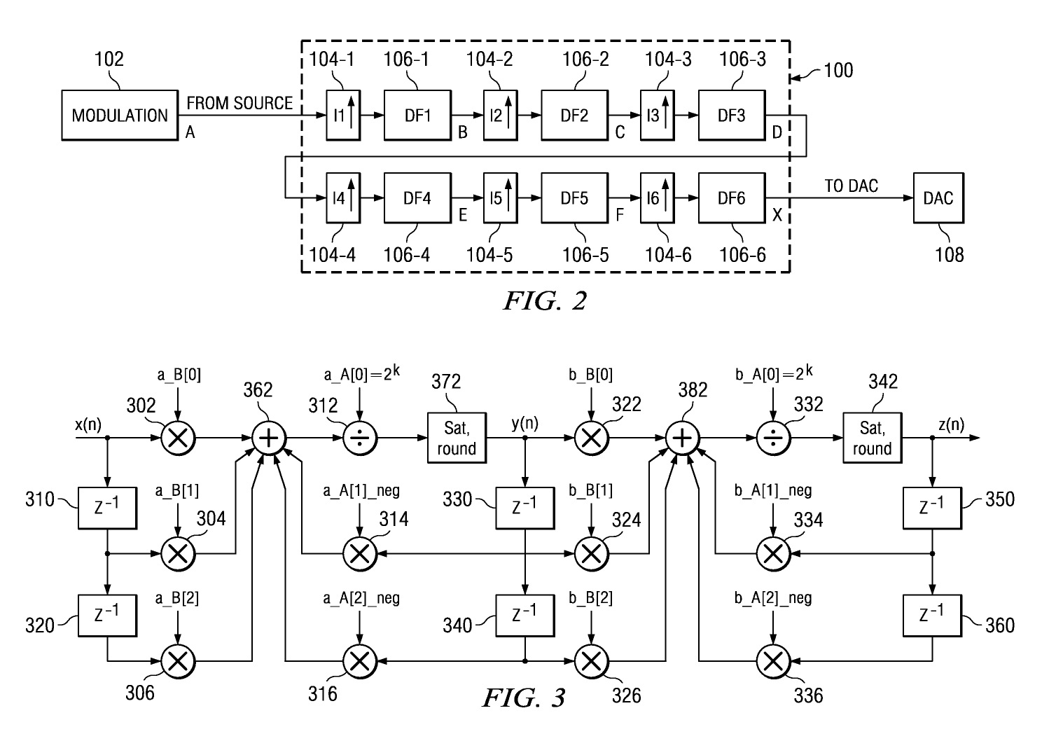

In a preferred embodiment as shown in FIG. 2, the digital filter processor hardware according to the present invention can support multiple digital filters simultaneously. Each filter property such as filter order, coefficient symmetry, half-band, and poly-phase can be programmed independently in order to support the different standards requirements and extract maximum throuput from a given hardware. According to a preferred embodiment of the present application, the DAC is run at a constant 70.656 MHz, which is the output rate, whereas the input data rate to transmitter varies from 276 kHz to 17,664 kHz. At that high output rate of 70.656 MHz, the digital filter processor hardware needs the implementation of interpolating digital filter in order to cope with the multi-rate output. The wide range of the transmitter input data rates corresponds to the range of the input rates that is required in order to comply with the various standards of the DSL applications.

Table 1 shows an example of different input data rates and corresponding interpolation factors for a chain of transmit digital filters that can be used with the implementation as shown in FIG. 2. In Mode#1 or Serial#1, the input and output rates are respectively 276 kHz and 70,656 kHz. Therefore, the interpolation factor L is equal to 256 (L=Output rate/Input rate), such that the number of clock/input is equal to 1536 (=6×interpolation factor). Table 1 illustrates seven different Modes from Mode1 to Mode7, but there may be more than seven Modes as will be shown in Table 2.

TABLE 1
Transmitter input data rates

| | Input Rate | Output Rate | Interpolation | clock/ |
|---|---|---|---|---|
| Sr.# | (kHz) | (kHz) | Factor (L) | input |
| 1 | 276 | 70656 | 256 | 1536 |
| 2 | 552 | 70656 | 128 | 768 |
| 3 | 1104 | 70656 | 64 | 384 |
| 4 | 2208 | 70656 | 32 | 192 |
| 5 | 4416 | 70656 | 16 | 96 |
| 6 | 8832 | 70656 | 8 | 48 |
| 7 | 17664 | 70656 | 4 | 24 |

As shown in FIG. 2, cascade interpolating digital filters I1-DF1 to I6-DF6 are used to achieve the desired interpolation factor L with the lowest number of computations. A non-interpolating filter meets the desired pre-compensation and higher frequency PSD (power spectral density) mask requirement by performing spectral shaping. To meet a lower frequency PSD mask requirement, the cascaded digital filters include one Infinite Impulse Response (IIR) digital filter. In total, the chain of transmit digital filters has six stages of cascaded digital filters as shown in FIG. 2.

First in the chain is an Infinite Impulse Response (IIR) filter 106-1 followed by five Finite Impulse Response (FIR) filters 106-2 to 106-6. At an input of each filter DF1 to DF6 referred as 106-1 to 106-6, there is a configurable interpolation block I1-to-16 referred as 104-1 to 104-6. According to the standards requirements, the digital filters 106-1 to 106-6 are enabled and the corresponding interpolation factors of 104-1 to 104-6 can be configured as given in Table 2 which describes ten modes Mode#1 to Mode#10.

For instance in Mode#1, DF1, which is an IIR digital filter, has an interpolation factor equal to 1 (with an interpolating factor equal to 1, the digital filter can be considered as a non-interpolating digital filter), whereas DF2 to DF5, which are FIR digital filters, respectively have interpolation factors equal to 2, 1, 2 and 2. DF2 to DF5 are standard poly-phase interpolating digital filters which follow the principles as described in FIG. 1A.

DF6, which is also a FIR digital filter, has an interpolation factor equal to 32. DF6 is a special FIR digital filter where a SINC filter is used for higher order of interpolation whose value can be as high as 32. For each mode from Mode#1 to Mode#10, the total interpolation factor L is obtained by the multiplication of DF1-DF6 interpolation factors. It should be kept in mind that DF1 interpolation factor is always equal to 1 from Mode#1 to Mode#8 such that it can be independently bypassed in any mode.

TABLE 2
Active digital filters and their interpolation factors

| | DF1 | DF2 | DF3 | DF4 | DF5 | DF6 | |
|---|---|---|---|---|---|---|---|
| | (l1) | (l2) | (l3) | (l4) | (l5) | (l6) | |
| MODE | IIR | FIR | FIR | FIR | FIR | FIR | L |
| 1 | 1 | 2 | 1 | 2 | 2 | 32 | 256 |
| 2 | 1 | 1 | 2 | 2 | 2 | 32 | 256 |
| 3 | 1 | 1 | 1 | 2 | 2 | 32 | 128 |
| 4 | 1 | 2 | 1 | 2 | 2 | 16 | 128 |
| 5 | 1 | 1 | 2 | 2 | 2 | 16 | 128 |
| 6 | 1 | 1 | 1 | 2 | 2 | 16 | 64 |
| 7 | 1 | 1 | 2 | — | — | 16 | 32 |
| 8 | 1 | 1 | — | — | — | 16 | 16 |
| 9 | — | 2 | 2 | 2 | — | — | 8 |
| 10 | — | 2 | 2 | — | — | — | 4 |

FIG. 3 schematically illustrates DF1 as a direct form of a two-cascaded 2^{nd} order biquad IIR filter. It should be kept in mind that the present invention DF1 may be implemented into a biquad IIR filter in a cascaded manner with a single multiply-and-accumulate stage, but any other implementation that performs the same function can also be used.

In the preferred embodiment, input datastream X(n) is a sequence of discrete input values which are processed by DF1 to produce a first output datastream Y(n) which is also a sequence of discrete values after the first cascaded 2^{nd} order biquad IIR filter and to produce a second output datastream Z(n) after the second cascaded 2^{nd} order biquad IIR filter. A first feed-forward is implemented by multiplier 302 for multiplying current input value X(n) by coefficient a_B[0], multiplier 304 for multiplying once delayed input value X(n−1) from delay stage 310 by coefficient a_B[1] and multiplier 306 for multiplying twice delayed input value X(n−2) from delay stage 320 by coefficient a_B[2]. On the feed-back side of the first cascaded 2^{nd} order biquad IIR filter, multiplier 314 multiplies once delayed first output Y(n−1) from delay stage 330 by coefficient a_A[1]_neg, and multiplier 316 multiplies twice delayed first output Y(n−2) from delay stage 340 by coefficient a_A[2]_neg. The outputs of multipliers 302, 304, 306 and 312, 314, 316 are all applied to inputs of an accumulator 362 whose resulting sum constitutes the first output datastream Y(n) after being divided by a coefficient a_A[0]=2^{k} in a divider 312 and going through a saturation and rounding operation in block 372.

The first output datastream Y(n) is then used an input in the second cascaded 2^{nd} order biquad IIR filter. A second feed-forward is implemented by multiplier 322 for multiplying current first output value Y(n) by coefficient b_B[0], multiplier 324 for multiplying once delayed first output value Y(n−1) from delay stage 330 by coefficient b_B[1] and multiplier 326 for multiplying twice delayed first output value Y(n−2) from delay stage 340 by coefficient b_B[2]. On the feed-back side of the second cascaded 2^{nd} order biquad IIR filter, multiplier 334 multiplies once delayed second output Z(n−1) from delay stage 350 by coefficient b_A[1]_neg, and multiplier 336 multiplies twice delayed second output Z(n−2) from delay stage 360 by coefficient b_A[2]_neg. The outputs of multipliers 322, 324, 326 and 332, 334, 336 are all applied to inputs of an accumulator 382 whose resulting sum constitutes the second output datastream Z(n) after being divided by a coefficient b_A[0]=2^{k} in a divider 332 and going through a saturation and rounding operation in block 392.

In a preferred embodiment, digital filter DF1 106-1 is a 4^{th} order IIR filter whereas digital filters DF2-to-DF5 106-2 to 106-5 are not interpolating but poly-phase in order to save computation. Digital filter DF6 106-6 is a special case where a SINC filter is used for higher order of interpolation. The SINC filter has the property of having a filter length same as interpolation factor. Thus by using a poly-phase structure, DF6 gives burst of output samples from DAC. And with the use of First-In-First-Out, the dusty samples are periodically given to DAC.

The transmitter digital filter logics use a 423.9 MHz clock, thus depending on the data rate, the numbers of clocks per input available with logics to provide corresponding outputs to the DAC are shown in Table 1. Since the DAC is running at 70.656 MHz, the FIFO generates an output every 6^{th} clock. The input to FIFO is a burst of 16 samples from DF6 after every 96 clocks. When DF6 is interpolating by an interpolation factor 32, the output is generated as two bursts of 16 samples separated by 96 clocks. When DF6 is inactive as in Mode#9 and Mode#10 in Table 2, the input to FIFO is irregular.

In order to design a digital filter hardware that could operate in the ten modes Mode#1 to Mode#10 of Table 2, the number of modes can be higher in another example, there is a need to build an optimized structure that can support multiple digital filters simultaneously, wherein each filter property such as filter order, symmetry coefficient, half-band and poly-phase can be programmed independently to comply with the different system requirements and to extract the maximum throughput of the digital filter hardware.

### Programmable Options

Table 3 shows the programmable control options for digital filters DF2 to DF5 according to a preferred embodiment wherein the FIR filters are implemented in cascaded as illustrated in FIG. 2. DF2 to DF5 have independent controlling registers, such as DFx_order, DFx_symmetric, DFx_hb where x represents the filter number from 2 to 5. And in this particular case, digital filter DF1 is an IIR filter and is bypassed.

TABLE 3
Controlling registers

| Programmable | |
|---|---|
| register | Comments |
| MODE | Mode of operation depending on desired interpolation |
| | factor of the complete filter chain |
| DF1_bypass | Bypass DF1 (IIR filter) |
| DFx_order | Order of filter (filter_length −1) |
| DFx_symmetric | 1, if hardware has to use coefficient symmetry |
| | property to reduce RAM and clock requirement |
| DFx_hb | 1, if hardware has to use half-band property for |
| | interpolating filter to decrease required number of |
| | clocks |

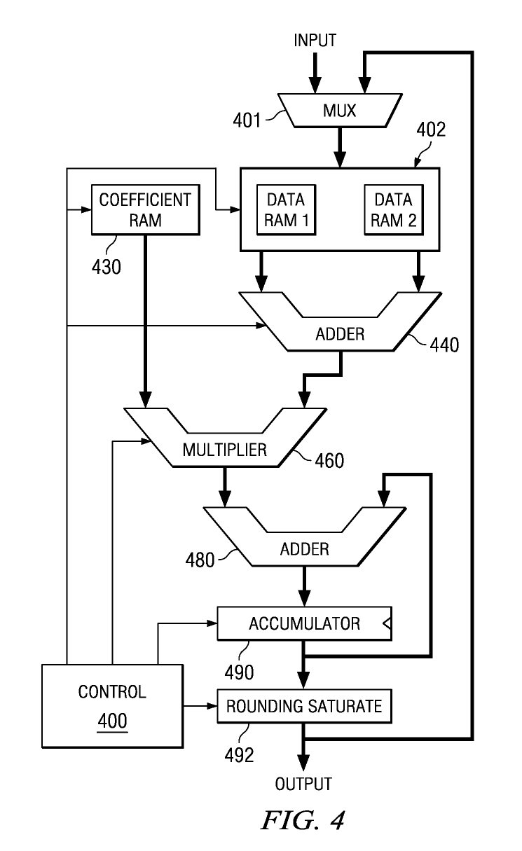

All digital filters in FIG. 2 have programmable coefficients. A single Coefficients RAM 430 is provided to the programmable coefficients of all the digital filters, as is shown in FIG. 4. In a preferred embodiment, the block diagram of the transmitter filter consists of a Coefficients RAM 430 with 192 locations provided to program the coefficients of all the filters, a Data RAM 402, a control logic or controller 400 and an Arithmetic Logic Unit (ALU) not shown in the figure. The preferred embodiment shows a single-port DATA RAM with two instances DATA1 RAM and DATA2 RAM of 164 locations to support the symmetric coefficient property where the digital filter needs 2 samples for one coefficient multiplication. The Coefficients RAM 430 is a single-port RAM that is programmed with the coefficients of the active filters.

As is shown in Table 3, DF1 is inactive, meaning that “DF1_bypass” bit is set to ‘1’. In such case, DF1 does not occupy any location in the coefficients RAM nor does it consume any clocks.

In a preferred embodiment, DF2 to DF5 are active or bypassed depending on the transmitter requirement as shown in Table 3. Because of their active status, they work either as non-interpolating filters or as interpolating filters with an interpolating factor equal to 2 by 2 filters, depending on the configuration as shown in Table 2. The outputs of these filters have scaling block where data amplitude can be scaled by “4, 2, 1 and ½” by programming signed value of “−2, −1, 0 and 2” respectively in a 2-bit “DFx_A[0]_shift” register. The filter order of each of these filters DF2 to DF5 is separately programmable by programming “DFx_order” register of the respective filter.

When “DFx_symmetric” bit is set to ‘1’, only half the coefficients are required to be programmed in the coefficient RAM. Only odd number of filter length (even order) is supported when using coefficient symmetric property. When the filter is in interpolating mode, the coefficients need to be programmed by splitting them into even and odd coefficient sets for poly-phase structure. Even coefficients are stored first followed by odd coefficients in the address range.

When “DFx_hb” bit is set to ‘1’, half-band property enables interpolating filters to consume minimum clocks without requiring to change the way the coefficients are programmed. The digital filters will use only centre odd coefficient while other odd coefficients are neglected and assumed to be zeros. Thus, using half band property will reduce the required number of cycles for odd coefficients to one.

If “DFx_symmetric” bit is set in interpolating mode, then only half the coefficients are required to be programmed for poly-phase structure. “DFx_hb” and “DFx_symmetric” bits can be set to ‘1’ at the same time to use both the symmetric coefficient property and the half band property together. Inactive filters are bypassed and do not occupy any location in the coefficients RAM 430 and the data RAM 402, and the corresponding filter registers are neglected. However when the filters are active, they consumes hardware resources according the requirements as shown in Table 4.

Table 4 shows different combinations of the Digital Filters parameters, whether the digital filter is an interpolating or non-interpolating filter, whether the “DFx_symmetric” and “DFx_hb” bits are set or not, whether the minimum number of taps (filter length) is 3 or 7. Table 4 determines the number of locations occupied in DATA RAM 402 being equal to DFx_order+1 if the DF_x order is an even number and being equal to fix(DFx_order/2)+1 if the DFx_order is an odd number. In the same way, the number of locations occupied in Coefficient RAM 430 is determined being equal to DFx_order+1 if the DFx_symmetric bit is set to ‘0’ and equal to DFx_order/2+1 if the DFx_symmetric bit is set to ‘1’. The number of cycles required per input sample is determined depending on whether the digital filter is an interpolating or non-interpolating filter. If it is an interpolating filter, the number of cycles required is split into two branches, an even coefficient branch DFx_EVEN and an odd coefficient branch DFx_ODD. Both branches will depend on the values of the DFx_order and DFx_symmetric bits. The number of cycles required must be an integer, therefore the fix function (that returns the largest integer less than or equal to the value) and ceiling function (that returns the smallest integer not less than the value) are used in the computations.

TABLE 4
Different memory and clock requirements for FIR filters

| | | | | | number of | | |
|---|---|---|---|---|---|---|---|
| | | | | number of | locations | | |
| | | | | locations | occupied in | | |
| Inter- | | | | occupied in Data | Coefficient | number of cycles required per input | |
| polating | DFx_symmetric | DFx_hb | Minimum # taps | RAM | RAM | sample | |
| N | 0 | x | 3 | DFx_order + 1 | DFx_order + 1 | DFx_order + 1 | |
| N | 1 | x | 3 | DFx_order + 1 | (DFx_order/2) + 1 | (DFx_order/2) + 1 | |
| | | | | | | even coefficients | odd coefficients |
| | | | | | | branch (DFx_EVEN) | branch |
| | | | | | | | (DFx_ODD) |
| Y | 0 | 0 | 7 | fix(DFx_order/2) + 1 | DFx_order + 1 | fix(DFx_order/2) + 1 | ceil(DFx_order/2) |
| Y | 0 | 1 | 7 | (DFx_order/2) + 1 | DFx_order + 1 | (DFx_order/2) + 1 | 1 |
| Y | 1 | 0 | 7 | (DFx_order/2) + 1 | (DFx_order/2) + 1 | fix(DFx_order/4) + 1 | ceil(DFx_order/4) |
| Y | 1 | 1 | 7 | (DFx_order/2) + 1 | (DFx_order/2) + 1 | fix(DFx_order/4) + 1 | 1 |

DF6 is a symmetric FIR filter with a Sinc frequency response and is configured according to the transmitter interpolation requirement. Accordingly, this filter has an interpolation factor of 16 or 32 as shown in Table 2, with the filter length being equal to the interpolation factor. DF6 is implemented as a poly-phase filter to perform one coefficient multiplication per output and it occupies sixteen or thirty-two 16-bit coefficients locations depending on the length of the filter. Since it is the last filter of the cascaded chain of filters, its 16/32 coefficients are placed after all other filters coefficients. Just like DF2 to DF5, the output of DF6 also has scaling block, where data amplitude can be scaled by “4, 2, 1 and ½” by programming signed value of “−2,−1, 0 and 2” respectively in a 2-bit “DF6_A[0]_shift” register.

Tables 3 and 4 illustrate the numerous possibilities of programming the digital filters that can be supported by the Digital Filter Processor (DFP). Almost all the plausible parameters of the digital filters are programmable, making the DFP as flexible as the DSP.

### Hardware implementation

As previously mentioned, the block diagram of the transmitter filter is illustrated in FIG. 4 with DATA RAM 402 comprising two instances of a 19-bit DATA RAM with 164 locations, a 16-bit Coefficient RAM 430 with 192 locations and a control logic 400. Coefficient RAM and DATA RAM may be realized as separate memory arrays or alternatively as portions of a single memory resource, depending on the implementation. It should also be kept in mind that the block diagram of the receiver filter that receive the signals on the other side of the channel can be implemented in the same way as the block diagram of the transmitter filter of FIG. 4.

A Multiplexer 401 receives the inputs which are then dispatched to the two instances of DATA RAM 402 whose outputs are added in an Adder 440 before generating outputs which are transmitted to a multiplier 460.

At this stage it should be kept in mind that control logic or Controller 400 is controlling the addressing and/or the accessing of Multiplexer 401, DATA RAM 402, Coefficient RAM 430 and Multiplier 460 by generating control signals depending on the programmed instructions of RAMs and ALU. Controller 400 preferably operates in response to decoded program instructions or other control signals produced elsewhere in the integrated circuit.

Multiplier 460 multiplies the coefficients from Coefficient RAM 430 with the data from DATA RAM 402 to generate a product. The product outputs of multiplier 460 are added in an Adder 480 with data in an Accumulator 490 before storing the product back in accumulator 490. As a matter of fact, the output of Adder 480 is coupled to the input of Accumulator 490, which accumulates the output from adder 480 with previously accumulated output when clocked. The output of Accumulator 490 is coupled back to Adder 480.

The data in Accumulator 490 are rounded and saturated in a Round and Saturate block 492 before they are stored back in DATA RAM 402, each time the intermediate filters outputs are ready. The intermediate filters outputs are outputs B, C to F from DF1 to DF5 as shown in the case of an implementation represented in FIG.2. Rounded and saturated data are generated when the last filter output is ready. And in the implementation of FIG. 2, the last filter is DF6. Round and saturate block 492 enables to limit the range of values to a pre-specified range.

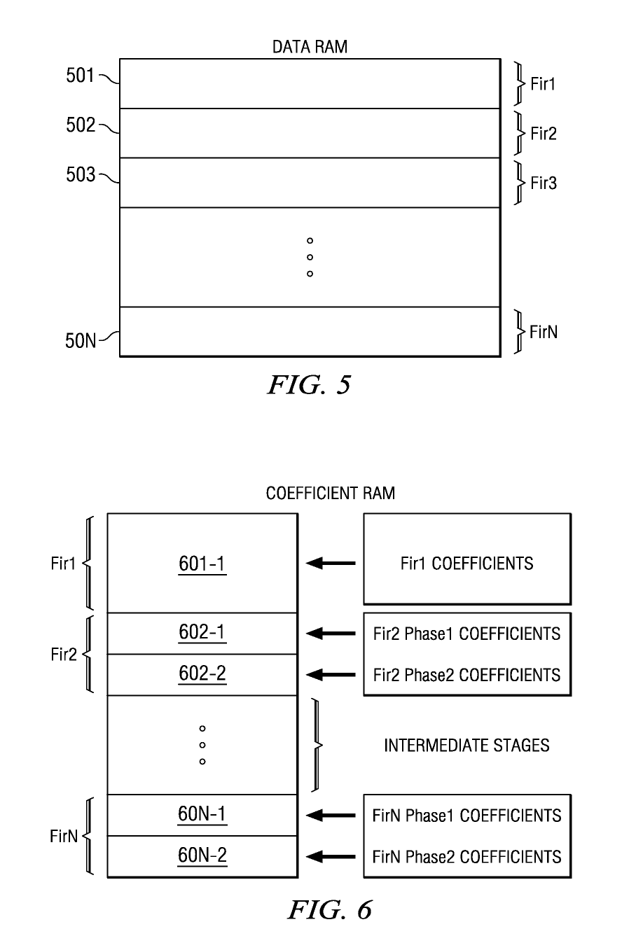

In a preferred embodiment, the two instances of the single-port DATA RAM 402 support the symmetric coefficient property where two samples are needed for one coefficient multiplication. The data for each filter are stored in continuous locations within a “DATA RAM segment” which is dedicated to the corresponding filter. As shown in FIG.5, the segmentation of the DATA RAM is represented wherein each filter is assigned a segment, i.e. Digital filter FIR1 is assigned a first segment 501, Digital filter FIR2 is assigned a second segment 502 and so forth. DATA RAM 402 is cleared on hard reset or when “TX_DATA_CLEAR” bit is set to ‘1’.

The Coefficient RAM 430 is a single-port RAM that can only be programmed with coefficients of active filters by the DSP. The coefficients of each filter are stored separately in different segments 601, 602, 603, . . . , as shown in FIG. 6. To each Digital Filter FIR1, FIR2, FIR3, etc. corresponds respectively a segment 601, 602, 603, etc. . By using the poly-phase property of the digital filters, the coefficients for these phases can be programmed to be stored in separate sub-segments 602-1, 602-2, 603-1, 603-2, etc. The preferred embodiment in FIG. 6 shows that FIR1 is programmed as a single phase filter whereas the other filters are programmed as poly-phase filters. For instance, FIR2 phase1 coefficients and FIR2 phase2 coefficients are respectively stored in sub-segment 602-1 and sub-segment 602-2.

The start and end address of segments are generated internally. When programming the controlling registers, shown in Table 3, the controller deciphers the register settings such as filter length, poly-phase etc. and creates the segmentation structure as shown in Table 4. The values in Table 4 are used to calculate the start address of the coefficient/data RAM and to keep track of the current coefficient RAM address and the current data RAM address when a particular filter state is active.

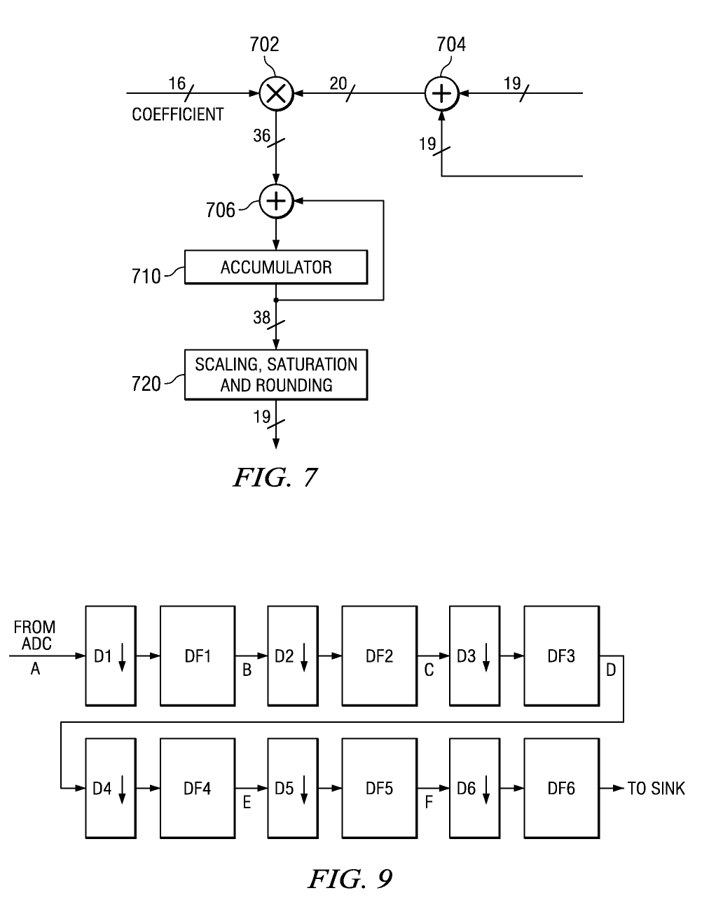

FIG. 7 can summarize the different operations performed in FIG. 4 and more specifically show the details of the compute unit. A single high speed ALU with a Multiplier-Accumulator structure refined for convolution operation can be used to run the computations of all the cascaded filters in the chain. In a preferred embodiment, the ALU/MAC can run at a speed of 424 MHz which is 24 times the highest input sampling rate, thus allowing all the computations to be done within the given sample period.

Depending on the programmed mode set in “MODE” register defined in Table 3, the interpolation factors for different filters are derived from Table 2. In one implementation, a single control register can be used to control all filter interpolation factors. In another implementation, the interpolation factor of each filter can be independently controlled by different control registers.

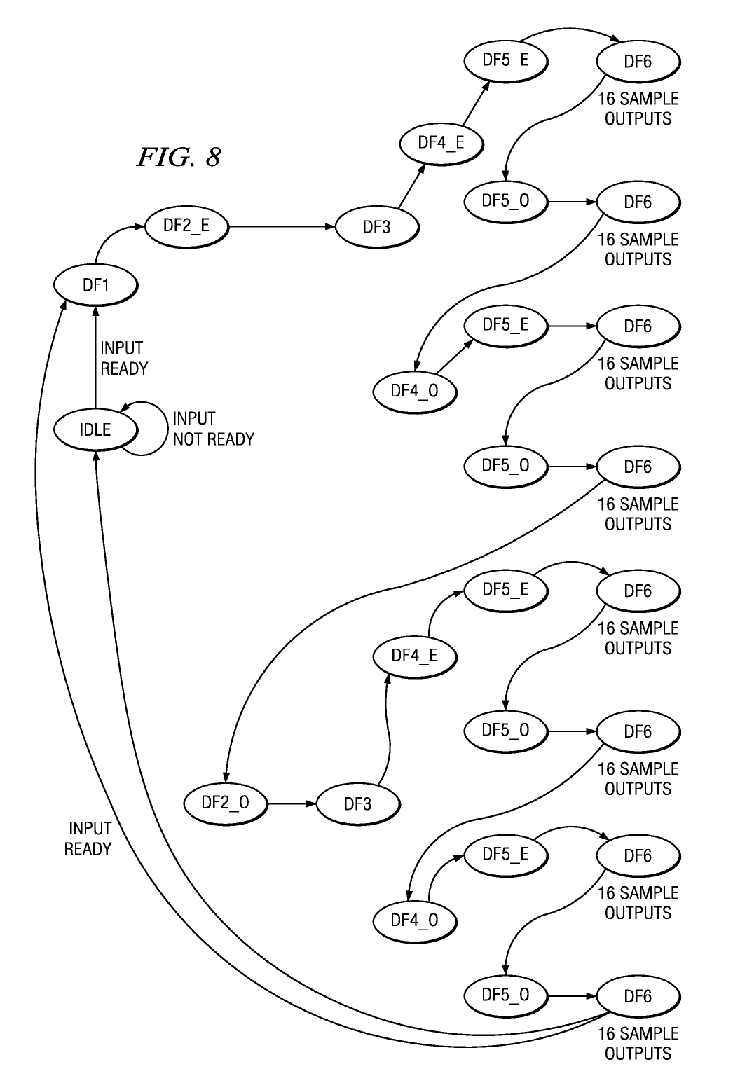

The “MODE” register also controls state-machine which schedule filter computations to a single ALU. The sequencer goes through different number of states for different structures following a poly-phase splitting strategy. The computation advances from one stage to another or from one phase of a stage to that of a next stage based on whether the stages are programmed to be poly-phase or not. FIG. 8 shows the states of the different filter computations in a particular mode “Mode#4” as shown in Table 2 where the state moves out of “IDLE” state after receiving an input sample and moves back to “IDLE” state before receiving a next periodic input sample.

In Mode#4, digital filters DF1 to DF6 are all active and have respectively interpolation factors 1, 2, 1, 2, 2, 16. DF1 and DF3 are simple digital filters. Since DF2, DF4 and DF5 are interpolating digital filters, according to Table 4, the number of cycles required per input sample is to be determined for the even coefficient branch and for the odd coefficient branch. The last digital filter DF6 has an interpolating factor of 16 and will therefore deal with 16 sample output. After the computation is completed in DF1 where the input is stored in DATA RAM in the allocated data RAM segment of DF1, the even coefficients DF2_E are being dealt with before the output is generated to DF3. Once the computation is completed in DF3, the output is generated to DF4 where the even coefficients DF4_E are being dealt with before the output is generated to DF5, where again the even coefficients DF5_E are being dealt with. DF6 receives the output from DF5 and performs 16 computations. Once they are completed, odd coefficients DF5_O are being dealt with before generating an output to DF6 where another 16 computations are performed again. Once they are completed, odd coefficients DF4_O are being dealt with before generating an output to DF5 where even coefficients DF5_E are being dealt with. DF6 receives the output from DF5 and performs 16 computations. Once they are completed, odd coefficients DF5_O are being dealt with before generating an output to DF6 where another 16 computations are performed for the 4^{th} time. Once they are completed, odd coefficients DF2_O are being dealt with and so on until all the even and odd coefficients of DF2, DF4 and DF5 are being dealt with.

For any mode, the state moves out of IDLE stage after receiving an input sample and moves back to “IDLE” state before receiving the next input sample. The hardware will ignore samples received in non IDLE states, whereas the software is programmed so as make the state machine come back to IDLE state before the next sample is received by programming the proper values in the registers. Only the sequence of the state for a given mode is hard coded in a design.

In a preferred embodiment, if required, the sequence of the state for any given mode can be programmable at the cost of area and verification effort. Only the sequence of the state is controlled by the “MODE” registers, but the operations and the number of clocks required by each state are controlled by other registers as shown in Table 3. For each filter there is separate hardware which computes the different values of the number of locations and clock requirements as given in Table 4. The values of the number of locations occupied in Data RAM and in Coefficient RAM are also used to calculate the start addresses of data/coefficient RAM and keep track of current coefficient and data RAM address when particular filter state is active.

Table 5 shows the number of available clock cycles per input sample for different input data-rates. The software has to configure the digital filters such the entire set of active filters complete their computations within the clocks available between two input samples. If the input sample is received when state is in its last stage, then the “IDLE” state is bypassed so that the ALU can use 100% clock for data computation. The software is also programmed so as to control the coefficient and data RAM sizes. The outputs will be junk if all active digital filters need more than 192 memory locations to store the coefficients or more than 164 memory locations to store the delay data since there is no extra hardware.

TABLE 5
Number of clocks between two input samples

| | Input data-rate (kbps) | | | | | | |
|---|---|---|---|---|---|---|---|
| | 276 | 552 | 1104 | 2208 | 4416 | 8832 | 17664 |
| No of clocks | 1536 | 768 | 384 | 192 | 96 | 48 | 24 |
| between two input | | | | | | | |
| samples | | | | | | | |

According to a preferred embodiment, the Digital Filter Processor is implemented in a 90 nm digital process using low area library. The total area of DFP is 0.095 mm² including the data and coefficient RAMs. If the DSP is running at 360 MHz, the C62x CPU area itself will require 0.83 mm² and the area for RAM, memory controller and logic to transfer data from RAM to DAC will be additional

Table 6 compares the performance MIPS/second/mm² of the C62X of the DSP configuration against the DFP configuration. It is clear that the DFP provides a true 10× improvement in performance per unit area of silicon.

TABLE 6
Comparison of Million MACS/sec/mm² between DSP and DFP

| | Sample | | | | |
|---|---|---|---|---|---|
| | Rate | MACs per | MMACs | Area | MMACS/ |
| | MSPS | Sample | per sec | sqmm | s/sqmm |
| TMS320C62X | 8832 | 55 | 485760 | 0.83 | 585253 |
| DSP | | | | | |
| Proposed | 8832 | 55 | 485760 | 0.09 | 5397333 |
| DFP | | | | | |

Table Table 7 shows the C62x DSP loading for running the same filters with an optimized software in the filters. In the fastest modes, the filters would occupy a maximum of 67% of the CPU availability, which is lower than the percentage of the CPU availability obtained with the DFP configuration.

TABLE 7
C62X DSP loading for same filters

| | Input | | | | | | | Required | Available | |
|---|---|---|---|---|---|---|---|---|---|---|
| | Rate | Order | | | | | | MACs per | MACs per | DSP |
| Mode | (KBPS) | DF1 | DF2 | DF3 | DF4 | DF5 | DF6 | input | input | loading |
| 1 | 276 | 4 | 62 | 30 | 14 | 6 | 31 | 389 | 2609 | 14.91% |
| 2 | 276 | 4 | 30 | 62 | 14 | 6 | 31 | 374 | 2609 | 14.32% |
| 3 | 552 | 4 | 30 | 62 | 14 | 6 | 31 | 231 | 1304 | 17.71% |
| 4 | 552 | 4 | 30 | 62 | 14 | 6 | 15 | 309 | 1304 | 23.65% |
| 5 | 1104 | 4 | 30 | 62 | 14 | 6 | 15 | 167 | 652 | 25.61% |
| 6 | 2208 | — | 60 | 6 | — | — | 15 | 66 | 326 | 20.24% |
| 7 | 4416 | — | 60 | — | — | — | 15 | 47 | 163 | 28.52% |
| 8 | 8832 | — | 18 | 18 | 6 | — | — | 43 | 82 | 52.13% |
| 9 | 8832 | — | 50 | 14 | 6 | — | — | 55 | 82 | 66.85% |
| 10 | 17664 | — | 30 | 10 | — | — | — | 27 | 41 | 65.01% |

According the invention, the concept of Digital Filter Processor (DFP) with a basic structure and a low area filter design has all the advantages in terms of Power Performance Area (PPA). Its advanced control logic provides all the flexibility needed to program desired filter parameters in the required configuration and still use 100% of available multiplier time and RAM area. The programmability provided by a DFP processor is very close to that provided by a Programmable DSP but without the cost of its large hardware. Thus DFP brings the best of the two configurations: PPA advantage with complete software controllability of the digital filter parameters.

FIG. 9 shows a receiver digital filter on the receiver side of the channel where a constant data rate ADC data is decimated to a desired data rate by a digital decimation filter for Sink. A poly-phase decimation filter is a poly-phase re-sampling filter which reduces the sample rate, wherein the output is generated at the lower frequency enabling subsequent components of the receiver digital filter to operate at lower frequency.

As shown in FIG. 9, a chain of cascaded digital filters D1-DF1 to D6-DF6 are used to achieve the desired decimation factor D with the lowest number of computations. The chain of cascaded decimating digital filters receives an input from an analog to digital converter (ADC). The input is then decimated and filtered through D1-DF1 to D6-DF6 before generating an output for Sink. The description given for FIG. 2 can also be used for the description for this FIG. 9 on the receiver side of the channel.

The processor architecture of the invention can be used for wireless technology and can be implemented in a transmitter and/or a receiver of the wireless device.

This processor architecture can be implemented for programmable digital filters which can be used to support multiple standards like G.dmt.992, G.dmt.bis, ADSL2+ and VDSL2. In another implementation, the processor architecture can also fit the use of a chip which consists of a TMS320C62x™ based DSL PHY comprising a Data Converter subsystem and Digital signal processing subsystems.

While the invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. Therefore, it is to be understood that the invention is not to be limited to the specific embodiments disclosed. Although specific terms are employed herein, they are used in a generic and descriptive sense only and not for purposes of limitation.

We claim:

1. A method of filtering digital signals in a programmable digital filtering device composed of a cascaded digital filters, the digital signals transmitted from a source with multiple sampling rates to a digital to analog converter with a single sampling rate, said method comprising:
determining an interpolation factor of the cascaded digital filters with the lowest number of computations so as to match with the single sampling rate of the digital to analog converter;
determining active filters and an interpolation factor of each digital filter in the cascaded digital filters; and
determining a mode of operation of the cascaded digital filters.

2. The method as defined in claim 1 wherein each digital filter in the cascaded filters has a programmable bypass register DFx_bypass which determines if the corresponding digital filter is active to define the mode of operation of the cascaded digital filters.

3. The method as defined in claim 1 wherein each digital filter in the cascaded filters has a programmable order register DFx order which determines an order of the corresponding digital filter to define the mode of operation of the cascaded digital filters.

4. The method as defined in claim 1 wherein each digital filter in the cascaded filters has a programmable symmetry register DFx_symmetric which determines coefficients symmetric property of the corresponding digital filter to define the mode of operation of the cascaded digital filters.

5. The method as defined in claim 1 wherein each digital filter in the cascaded filters has a programmable half-band register DFx_hb which determines half-band property of the corresponding digital filter to define the mode of operation of the cascaded digital filters.

6. The method as defined in claim 4 further comprising:
storing data for each digital filter in continuous locations within a Data segment of a Data RAM dedicated to the corresponding filter;
for poly-phase filters, splitting coefficients into a first set of even coefficients and a second set of odd coefficients and storing each set of coefficients in a sub-segment of a Coefficient segment of a Coefficient RAM dedicated to the corresponding filter; and
for single phase filters, storing coefficients in continuous locations within a Coefficient segment of a Coefficient RAM dedicated to the corresponding filter.

7. The method as defined in claim 6 further comprising the steps of:
using digital filter order of each digital filter to determine a number of locations occupied in the Data RAM and in the Coefficient RAM of the corresponding digital filter; and
using the number of locations occupied in the Data and Coefficient RAM to determine start addresses of the data and coefficients and to keep track of the current coefficients and data RAM.

8. The method as defined in claim 7 further comprising:
determining number of cycles required per input sample to assure that active filters complete computations within available clocks between two input samples.

9. A processor architecture for transmitting digital signals comprising a programmable digital filtering device coupled to a source for filtering digital signals generated by the source at multiple sampling rates, the programmable digital filtering device comprising:
a cascaded digital filters with independently programmable controlling registers and independent interpolating factors; and
a digital to analog converter for converting the digital signals into analog signals with a constant sampling rate which matches with the interpolating factors of the cascaded digital filters.

10. The processor architecture as defined in claim 9 wherein the programmable controlling registers comprise DFx-order registers which determine an order of each of the cascaded digital filters.

11. The processor architecture as defined in claim 9 wherein the programmable controlling registers comprise DFx_symmetric registers which determine coefficients symmetric property of each of the cascaded digital filters.

12. The processor architecture as defined in claim 11 wherein a single-port DATA RAM with two instances DATA1 RAM and DATA2 RAM is implemented to support the symmetric coefficient property and a single-port Coefficient RAM is programmed with the coefficients of active digital filters of the cascaded digital filters.

13. The processor architecture as defined in claim 12 wherein for each of the cascaded digital filters in interpolating mode, the coefficients are split into a first set of even coefficients and a second set of odd coefficients to be stored their respective addresses ranges.

14. The processor architecture as defined in claim 9 wherein the programmable controlling registers comprise DFx_hb registers which determine half-band property of each of the cascaded digital filters.

15. The processor architecture as defined in claim 9 wherein the programmable controlling registers comprise DFx symmetric registers and DFx-hb registers which respectively determine coefficients symmetric property and half-band property of each of the cascaded digital filters.

16. The processor architecture as defined in claim 9 wherein the cascaded digital filters comprises at least one programmable infinite impulse response digital filter and more than one finite impulse response digital filters.

17. The processor architecture as defined in claim 9 wherein the cascaded digital filters has a first digital filter which is a two cascaded 2^{nd} order biquad infinite impulse response digital filter.

18. The processor architecture as defined in claim 9 wherein the cascaded digital filters has a last digital filter which is a programmable symmetric finite impulse response poly-phase filter.

19. The processor architecture as defined in claim 9 wherein the number of digital filters in the cascaded digital filters is programmable.

20. The processor architecture as defined in claim 9 to be used in a multi-standard integrated circuit.

21. The processor architecture as defined in claim 9 to be used in a wireless device.

22. A processor architecture for receiving digital signals comprising a programmable digital filtering device coupled to a Sinc at multiple sampling rates for filtering the digital signals received at a constant sampling rate, the programmable digital filtering device comprising:
a cascaded digital filters with independently programmable controlling registers and independent decimating factors; and
an analog to digital converter for converting the analog signals into digital signals with a multiple sampling rate which matches with the decimating factors of the cascaded digital filters.

23. The processor architecture as defined in claim 22 wherein the programmable controlling registers comprise DFx_order registers which determine an order of each of the cascaded digital filters.

24. The processor architecture as defined in claim 22 wherein the programmable controlling registers comprise DFx_symmetric registers which determine coefficients symmetric property of each of the cascaded digital filters.

25. The processor architecture as defined in claim 22 wherein the programmable controlling registers comprise DFx_hb registers which determine half-band property of each of the cascaded digital filters.

26. The processor architecture as defined in claim 22 wherein the programmable controlling registers comprise DFx-symmetric registers and DFx_hb registers which respectively determine coefficients symmetric property and half-band property of each of the cascaded digital filters.

27. The processor architecture as defined in claim 22 wherein the cascaded digital filters comprises at least one programmable infinite impulse response digital filter and more than one finite impulse response digital filters.

28. The processor architecture as defined in claim 22 wherein the number of digital filters in the cascaded digital filters is programmable.

29. The processor architecture as defined in claim 22 to be used in a multi-standard integrated circuit.

30. The processor architecture as defined in claim 22 to be used in a wireless device.
